(19) United States
(12) Patent Application Publication
(10) Pub. No.: US 2007/0047921 A1
(43) Pub. Date: Mar. 1, 2007

(54) Optical disc player and its playing method

(75) Inventors: Declan Patrick Kelly, Eindhoven (NL); Bei Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/578,378

(22) PCT Filed: Nov. 3, 2004
(86) PCT No.: PCT/IB04/52277

§ 371 Date: May 5, 2006

(30) Foreign Application Priority Data
Nov. 10, 2003 (CN) 200310116104.0

(51) Int. Cl. H04N 5/00

(52) U.S. Cl. 386/125

(57) ABSTRACT

A playing of method an optical disc player (10) comprises the steps of: detecting the playing status (s210) searching URLs corresponding to information which is not downloaded yet if the detected playing status is abnormal, yet (s230); downloading the information required in the normal status according to the searched-out URLs (S250) while the player is in the abnormal status.

### BACKGROUND OF THE INVENTION

The present invention relates to a player and its playing method, in particular to an optical disc player and its playing method.

With rapid development of optical discs and optical disc playing techniques, more and more optical disc information is separated and stored in a network server, in order that other information which was not considered when the optical disc was being produced can be momently added into the network server while the storage burden of a optical disc is reduced, and thus the users are provided with more entertainment information and better playing effect.

There are various kinds of optical discs as described above, such as Blu-ray Disc and eDVD (enhanced DVD). Furthermore, the separated information described above is often JAVA application information, audio, caption, animate and advertisement, and the like.

As stated above, if part of information in an optical disc has been stored in a network server, the corresponding downloading operation must be available, in order that the information stored on the network server can be downloaded to a n optical disc player to play the optical disc in coordination with the corresponding information stored thereon.

The players in prior art play while downloading when they are downloading information. After the information has been downloaded from a network server, however, the process of reading out the previously downloaded information would be apparently a little slower than the process of reading out information directly from the optical disc. Thus it is difficult to synchronize playing the downloaded information with playing the information stored on the optical disc. In addition, when the network bandwidth is not sufficient or the network speed is too slow, the process of information downloading becomes much slower, which likely leads to the result that the optical disc is not played smoothly, even the case that playing is interrupted will occur, and thereby discounting the viewing interest of the user significantly.

Therefore, there is a need for an optical disc player and its playing method to avoid the above disadvantages.

### BRIEF SUMMARY OF THE INVENTION

The present invention is to provide a player which downloads in advance the information required in a normal playing status while the player is being in an abnormal playing status, wherein the abnormal playing status refers to pause status, copyright information status, director annotation status, and the like.

The present invention also provides a method which downloads in advance the information required in the normal playing status while the player is being in the abnormal playing status.

The technical problems to be solved by present invention are realized by the following technical solutions: the player described by present invention comprises a detecting module, a searching module, and a network management apparatus. The detecting module is used to detect whether the player is under the abnormal playing status or not, and send a searching command when the abnormal playing status is detected out. The searching module is used to search the URL corresponding to the information which is not downloaded with the searching command. And the network management apparatus is used to download the information required in the normal playing status according to the searched URL corresponding to the information which is not downloaded while the player is being in the abnormal playing status.

The optical disc playing method described by present invention is to first detect the playing status, search the URL corresponding to the information which is not downloaded if the detected playing status is abnormal, and then download the information required in the normal playing status while the player is being in the abnormal playing status.

Since the information required in the normal playing status can be downloaded in advance while the player is being in the abnormal playing status such as pause status, copyright information status or director annotation status, the phenomena such as playing is not smoothly, even playing is interrupted and so on can be avoided during the process of playing while downloading.

The other objects and achievements of present invention and thorough understanding of the present invention will be clear and apparent with reference to the following description and claims in connection with the accompanying drawings.

### BRIEF DESCRIPTION OF THE DRAWINGS

The present invention will be illustrated in more details by way of example and with reference to the accompanying drawings.

FIG. 1 is a structural schematic diagram of the optical disc player according to an embodiment of present invention;

FIG. 2 is a flow chart of playing of the optical disc player illustrated in FIG. 1.

In all the above accompanying drawings, the same signs represent similar or corresponding features and functions.

### DETAILED DESCRIPTION OF THE INVENTION

The content stored in a optical disc comprises the essential content users want to view, the URLs (Uniform Resource Locator) list corresponding to the information required to be downloaded, and other accessory information. The so-called other accessory information refers to the copyright information and the director annotation, and the like.

The optical disc playing process includes a normal playing status (the status that the essential content of a optical disc is being played normally) and an abnormal playing status. The abnormal status includes pause status, copyright information status (some text information used by copyright warning) and director annotation (some explanatory words used by director annotation), and the like. The player can play while downloading information while it is being in the normal playing status, the information required to be downloaded can be used directly without downloading if it has been stored temporarily in the storage of the player.

The optical disc player provided by present invention can play while downloading information while it is being in the normal playing status; and can download in advance the information required to be downloaded in the normal playing status while it is being in the abnormal playing status besides the normal playing status. The information required to be downloaded in the normal playing status is downloaded in advance while the player is being in the abnormal playing status, and the downloaded information is stored in the player in order to be used directly without being downloaded while the player is being in the normal playing status, thereby avoiding the phenomena that the playing is not smooth, even the playing is interrupted caused by playing while downloading.

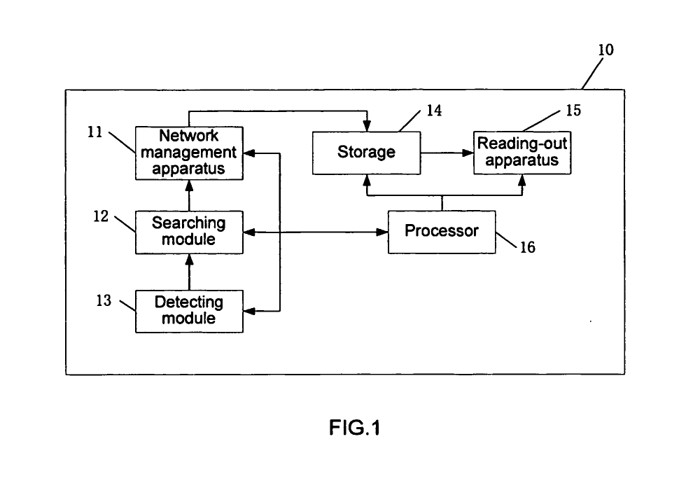

FIG. 1 is a structural schematic diagram of the optical disc player 10 according to an embodiment of present invention. The player 10 comprises a network management apparatus 11, a searching module 12, a detecting module 13, a storage 14, a reading-out apparatus 15 and a processor 16, wherein the processor 16 is used to control the working process of other components of the player 10.

The detecting module 13 is used to detect the player 10 is currently under the normal playing status or under the abnormal playing status during playing a optical disc (not shown), and send a searching command to the searching module 12 if the player 10 is detected as being in the abnormal status. The searching module 12 is used to search whether there are URLs corresponding to the information which is not downloaded in the URLs list of the optical disc according to the searching command.

The network management apparatus 11 is used to download information and transfer the downloaded information to the storage 14 for storing. Of course, under the abnormal playing status the network management apparatus 11 can download information after receiving the URLs that are searched by the searching module 12 and correspond to the information which is not downloaded, and then store the downloaded information into the storage 14, in order that the optical disc is played in coordination with the information stored in the optical disc when normal playing is resumed; the network management apparatus 11 can also download the above information during normal playing, in order that the player 10 can play the optical disc in coordination with the downloaded information while downloading. The reading-out apparatus 15 is used to read out the information stored in an optical disc and the information stored in the storage 14 to achieve smooth playing.

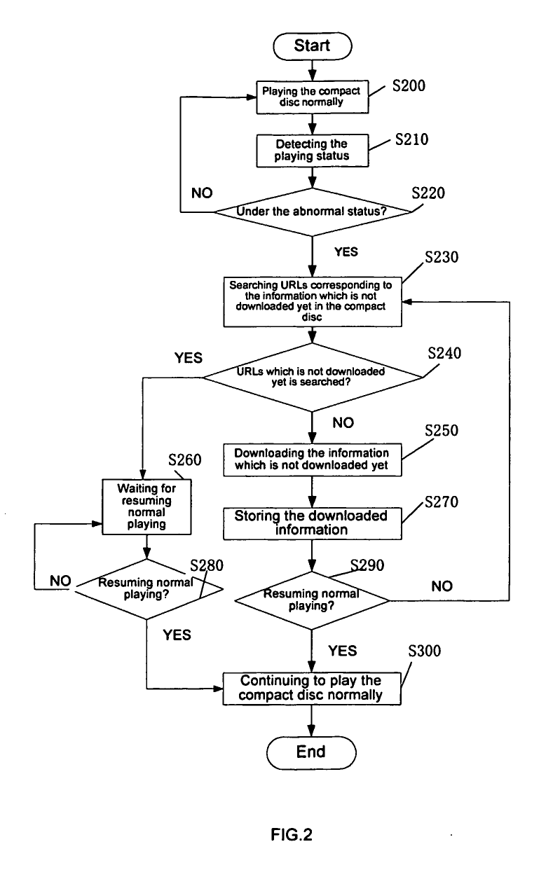

FIG. 2 is a flow chart when the optical disc player 10 is playing a optical disc.

The player 10, during the process of playing a optical disc normally (step S200), firstly detects whether the current playing status is normal or abnormal (step S210).

Second, the player 10 that currently plays the optical disc is determined whether it is under the abnormal playing status (step 2S20) according to the detected result. If the player 10 is under the normal playing status, it continues to play the optical disc normally (step S200); if the player is under the abnormal playing status, the URLs corresponding to the information which is not downloaded are searched in the URLs list in the optical disc (step S230).

Next, it is determined whether there are URLs corresponding to the information which is not downloaded according to the aforesaid search result (step S240), if no URL corresponding to the information which is not downloaded is searched, the player directly waits for resuming the normal playing of the optical disc (step S260). During the waiting for resuming normal playing, whether or not to resume normal playing of the optical disc is determined by the user (step S280), if normal playing needs to be resumed, the player continues to play the optical disc normally (step S300); if normal playing has not been resumed, the player returns and continues to wait for resuming normal playing (step S260).

If there are URLs corresponding to the information which is not downloaded found in the optical disc storage via judgement, the information corresponding to the URLs is downloaded in advance (step S250) and the information that is downloaded in advance is stored in the player 10, in order that the downloaded information in storage of the optical disc player 10 can be used directly when normal playing is resumed, thereby reducing the occurrence of interruption or hiccough during the process of playing while downloading (Step S270).

After the downloaded information is stored temporarily, it is determined by the user whether or not the normal playing needs to be resumed (step S290), if it needs to resume the normal playing, the player continues to play the optical disc normally (step S300), if it does not need to resume the normal playing, the player returns and continues its searching to confirm whether there are URLs corresponding to the information which is not downloaded (step S230), and repeats the above steps.

Since the information required in the normal playing status can be downloaded in advance while the player is in the abnormal playing status, such as pause status, copyright information status or director annotation status, the cases such as playing is not smooth, even playing is interrupted and so on can be avoided during the process of playing while downloading.

Although the present invention has been described in combination with a particular embodiment, according to the previous description, however, various alternatives, modifications and changes will be apparent for those skilled in the art. Therefore, the present invention will include all the alternatives, modifications and changes falling within the spirit and scope of appended claims.

What is claimed is:

1. An optical disc player, comprising:
a detecting module for detecting whether the player is under the abnormal playing status, and sending a searching command when the abnormal playing status being detected out;
a searching module for searching the URL corresponding to the information which is not downloaded according to the searching command; and
a network management apparatus for downloading the information required in the normal status utilizing the searched URL corresponding to the information which is not downloaded while the player being in the abnormal status.

2. The optical disc player according to claim 1, further comprising:
a storage for storing the information before it being downloaded to directly use this information under the normal status.

3. The optical disc player according to claim 1, wherein the abnormal status including the pause status.

4. The optical disc player according to claim 1, wherein the abnormal status including the copyright information status.

5. The optical disc player according to claim 1, wherein the abnormal status including the director annotation status.

6. A playing method of optical disc, comprising:
(a) detecting the playing status;
(b) searching the URL corresponding to the information which is not downloaded if the detected playing status is abnormal; and
(c) downloading the information required in the normal playing status according to the searched-out URL while the player being in the abnormal status.

7. The playing method of optical disc according to claim 6, wherein the step (b) comprising waiting until the playing status returns to normal if the URL of the information which is not downloaded is not searched out.

8. The playing method of optical disc according to claim 6, further comprising storing the downloaded information in a storage of the player.

9. The playing method of optical disc according to claim 6, wherein the abnormal status including the pause status.

10. The playing method of optical disc according to claim 6, wherein the abnormal status including the copyright information status.
